(19) United States
(12) Patent Application Publication
(10) Pub. No.: US 2016/0113237 A1
(43) Pub. Date: Apr. 28, 2016

(54) PORTABLE PET CARRIER AND VEHICLE TRANSPORTATION BAG

(71) Applicant: Juls Bindi, Beverly Hills, CA (US)

(72) Inventor: Juls Bindi, Beverly Hills, CA (US)

(21) Appl. No.: 14/521,209

(22) Filed: Oct. 22, 2014

(51) Int. Cl. A01K 1/02

(52) U.S. Cl. CPC A01K 1/029; A01K 1/0254

(57) ABSTRACT

A portable pet carrier and vehicle transportation bag. The bag includes a plurality of straps that are capable of independently disconnecting from one another for securing and adjusting the straps around one or more components in an interior cabin of a vehicle. Stabilizing bars or elements disposed within an interior cavity of the bag help ensure balanced operation when the bag is secured within the interior cabin of the vehicle. The bag is adapted to engage with a removable cover, either during manufacturing or by a consumer for altering the look or functionality of the bag as desired. The bag may have removeable straps (e.g., can be used as animal leashes), removeable flaps (e.g., may be used as animal water bowls), or heating or cooling packets inserted into interior pockets of the bag.

### CROSS REFERENCE TO RELATED APPLICATIONS

This application is a continuation-in-part of U.S. Non-Provisional application Ser. No. 13/941,103, filed on Jul. 12, 2013 and entitled “PORTABLE PET CARRIER AND VEHICLE TRANSPORTATION BAG,” which claims the benefit of and priority to U.S. Provisional Patent Application Ser. No. 61/713,414, filed on Oct. 12, 2012 and entitled “PORTABLE PET CARRIER AND VEHICLE TRANSPORTATION BAG,” which are hereby incorporated by reference in their entirety.

### BACKGROUND

1. Field

The present invention relates generally to pet carriers. More particularly, the present invention relates to pet carrier bags or purses capable of secure or stable mounting within an automobile or other vehicle.

2. Description of the Related Art

Personal and family pets are increasingly being brought by their owners outside of the home, whether to travel for their own entertainment, such as by traveling heading to park or beach location and to visit and romp with other animals, or simply to accompany their owners in performance of daily tasks or chores, such as shopping, picking up children from school, or any of a variety of other everyday activities. Society has become increasingly receptive to the allowance of pets at stores or restaurants with their owners, making such pet travel more common, particularly in more urban environments. Indeed, an entire industry has arisen for catering to the needs and comfort of these more mobile pets, including animal carriers or bags that allow small dogs, cats, or other smaller animals to accompany their owners by resting within an enclosure as it is carried or otherwise transported by the owner.

Unfortunately, while the current carriers allow for pet accompaniment when the owner is walking, they have not effectively solved the problem of convenient and comfortable travel for the animal during transition to or when within an automobile. In many geographic areas, the distance between an owner's home and the stores or other locations desired for travel are not easily walkable, requiring the owner to engage in the assistance of a motor vehicle to reach their chosen destination. Thus, the owner who wishes his or her animal to accompany on the trip must either place the carrier with the animal on one of the spare seats of the vehicle or some other empty location along the floor of the vehicle and attempt to fasten the seat belt around or to the carrier to help ensure the animal's safety in the event of a crash.

Such systems are problematic for both the animal and other occupants of the vehicle. The pet is often forced to remain in the carrier without visibility of the vehicle windows, increasing anxiety and preventing a view outside of the automobile, a favorite activity for many animals. In addition, this carrier placement also requires the availability of empty seats or other accommodating floor space in the vehicle. Particularly on long trips, such as family vacations or during household moves, where large amounts of baggage or other goods accompany a fully-occupied automobile, there is no adequate space for the pet carrier to sit. In these circumstances, one of the vehicle occupants is commonly required to suffer the pet carrier on their lap or share their seat or foot space with the enclosure. Alternatively, the owner may opt to let the animal out of the carrier once inside the vehicle and allow their pet to roam about the interior cabin. While the pet may be happier, these situations can be dangerous and distracting for the driver and provides no protection for the animal in the event of a crash.

Thus, an improved pet carrier that is capable of easy mounting to unused or lesser-used space in an automobile or other vehicle is desired. The improved pet carrier would ideally function as both a portable pet bag and carrier for an owner when walking and easily convert or mount to one or more portions of a vehicle for automotive travel. The improved pet carrier would desirably be stabilized and comfortable for the pet When in an automobile, even when traveling around curves or along uneven roads and allow the animal inside the carrier to look outside the windows of the vehicle for increased animal enjoyment and lower animal stress.

### SUMMARY

A portable pet carrier for use either during walking or during automotive travel is disclosed. In one embodiment, an enclosure for an animal may include a body defining a cavity therein for receiving the animal, the body configured to allow for complete enclosure of the cavity. A first strap is coupled with the body and a second strap coupled with the body and configured to releasably couple with the first strap to form a first combined strap. A third strap coupled with the body and a fourth strap coupled with the body and configured to releasably couple with the third strap to form a second combined strap.

In another embodiment, a method for transporting an animal in a vehicle having a driver seat with a driver headrest and a passenger seat with a passenger headrest may include providing a bag for receiving the animal within the bag, the bag having a first strap with an adjustable length, a second strap with an adjustable length, and a stabilizing rod for balancing the bag, securing the first strap around at least a portion of the driver headrest, securing the second strap around at least a portion of the passenger headrest, and adjusting the length of the first strap or the second strap for positioning the bag in a desired position between the driver seat and the passenger seat.

In still another embodiment, an enclosure for accommodating a pet may include a body having a bottom side, a top side, a front side, a back side, a first lateral side, and a second lateral side, the body defining a cavity therein for receiving the pet between the bottom side, the top side, the front side, the back side, the first lateral side and the second lateral side. A first strap has a first end and a second end and the first end of the first strap is connected to the body adjacent to a connection of the front side with the top side and the first lateral side. A second strap has a first end and a second end and the first end of the second strap is connected to the body adjacent to a connection of the back side with the top side and the first lateral side, the second end of the second strap configured to releasably connect with the first strap. A third strap has a first end and a second end and the first end of the third strap is connected to the body adjacent to a connection of the front side with the top side and the second side. A fourth strap has a first end and a second end and the first end of the fourth strap is connected to the body adjacent to a connection of the back side with the top side and the second side, the second end of the fourth strap configured to releasably connect with the third strap. At least one stabilizing rod extends along the first lateral side or the second lateral side for balancing the body.

In still another embodiment, an enclosure for an animal may include a body defining a cavity therein for receiving the animal, the body having at least one opening for allowing access to the cavity of the body, a first flap configured to close the opening by coupling with the body around at least a portion of the perimeter of the opening, and a second flap configured to cover the first flap by coupling with the body around at least a perimeter of the first flap. An adjustable exterior strap having a first fastener at a first end and a second fastener at a second end, may be coupled with the body via the first fastener and the second fastener and an interior strap having a first fastener at a first end and a second fastener at a second end, the interior strap coupled with the body, within the cavity, via the first fastener.

In still another embodiment, an enclosure for an animal may include a body defining a cavity therein for receiving the animal, the body having an opening for allowing access to the cavity of the body and a flap coupled with the body and configured to be completely removeable from the body, wherein the flap is configured to hold a volume of fluid thereon when removed from the body.

In still another embodiment, an enclosure for an animal may include a body defining a cavity therein, the body having an opening for allowing access to the cavity of the body, a pocket coupled with the body within the cavity, the pocket configured to hold a temperature altering element for altering a temperature within the cavity of the body, and an adjustable strap having a first fastener at a first end and a second fastener at a second end, the adjustable strap configured to removeably couple with the body via the first fastener or the second fastener, wherein the adjustable strap is configured to be completely removed from the body and used as a leash for the animal.

### BRIEF DESCRIPTION OF THE DRAWINGS

Other systems, methods, features, and advantages of the present invention will be or will become apparent to one with skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale and may be exaggerated to better illustrate the important features of the present invention. In the drawings, like reference numerals designate like parts throughout the different views, wherein:

FIG. 1 shows a side view of a portable pet carrier and vehicle transportation bag in use during personal carriage according to one embodiment of the present invention;

FIG. 2A shows a front view of a portable pet carrier and vehicle transportation bag in use during personal carriage via a shoulder of a user according to one embodiment of the present invention;

FIG. 2B shows a front view of the portable pet carrier and vehicle transportation bag of FIG. 2A in use during personal carriage via the hands of a user according to one embodiment of the present invention;

FIG. 3A shows a front view of a portable pet carrier and vehicle transportation bag in use during vehicle travel and having an animal able to look a front of the vehicle according to one embodiment of the present invention;

FIG. 3A shows a perspective view of the portable pet carrier and vehicle transportation bag of FIG. 3A in use during vehicle travel and having an animal able to look toward a rear of the vehicle according to one embodiment of the present invention;

FIG. 3C shows a perspective view of the portable pet carrier and vehicle transportation bag of FIG. 3A in using during vehicle travel and having an animal able to look toward a roof of the vehicle according to one embodiment of the present invention;

FIG. 4A shows a perspective exterior view of a portable pet carrier and vehicle transportation bag according to one embodiment of the present invention;

FIG. 4B shows a top exterior view of the portable pet carrier and vehicle transportation bag of FIG. 4A according to one embodiment of the present invention;

FIG. 4C shows a side exterior view of the portable pet carrier and vehicle transportation bag of FIG. 4A according to one embodiment of the present invention;

FIG. 5A shows a zoomed-in view of a buckle coupling device for use in connecting a portable pet carrier and vehicle transportation bag to a vehicle according to one embodiment of the present invention;

FIG. 5B shows a zoomed-in view of a clip coupling device for use in connecting a portable pet carrier and vehicle transportation bag to a vehicle according to one embodiment of the present invention;

FIG. 6 shows a perspective view of a portable pet carrier and vehicle transportation bag with a removable exterior cover according to one embodiment of the present invention;

FIG. 7A shows an interior view of a portable pet carrier and vehicle transportation bag according to one embodiment of the present invention;

FIG. 7B shows an animal connected with the portable pet carrier and vehicle transportation bag of FIG. 7A according to one embodiment of the present invention;

FIG. 8 shows a perspective view of a portable pet carrier and vehicle transportation hag according to one embodiment of the present invention; and

FIG. 9 shows a perspective view of a strap from a portable pet carrier and vehicle transportation bag according to one embodiment of the present invention.

### DETAILED DESCRIPTION

The detailed description of exemplary embodiments herein makes reference to the accompanying drawings and pictures, which show the exemplary embodiments by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

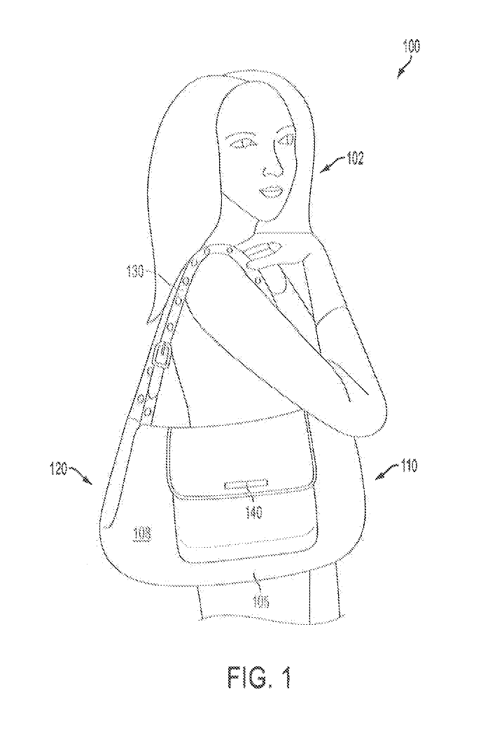

Turning first to FIG. 1A, a side view 100 of a portable pet carrier and vehicle transportation bag 105 is shown while being carried by a user 102. The portable pet carrier and vehicle transportation bag 105 includes a body portion 108 that contains a volume of space within suitable for receiving a pet or animal, for example, small dog breeds or cats. The body portion 108 of the bag 105 has a front end 110 and a back end 120. Differing materials may be used at the front end 110 and at the back end 120 of the body portion 108 of the bag 105. For example, the front end 110 may utilize a mesh or other transparent material such that the animal may peer out of the front of the body portion 108 through the mesh or other transparent material. Alternatively, the same material may be used at both the front end 110 and the back end 120 of the bag. In one embodiment, the front end 110 may be configured to open (e.g., via a zipper or flap) to allow the animal to stick its head out of the body portion 108 of the bag 105. Alternative embodiments may allow various portions or areas (e.g., the back end 120, a top portion, etc.) to open or allow an animal to peer out.

A plurality of straps 130 are fastened or otherwise connectible (e.g., using clips or any other type of fastener or connector) to the body portion 108 of the bag 105 at both the front end 110 and the back end 120. The straps 130 allow the user 102 to easily carry the body portion 108 of the bag 105 by draping the straps 130 over their shoulder, as shown. By carrying the bag 105 in this way, particularly when it is weighed down with an animal contained therein, muscle strain and discomfort may be lessened for the user 102. The bag 105 also includes a pocket 140 (e.g., coupled on an exterior surface of the body portion 108 or integrated into the body portion 108) so that the user 102 may place personal belongings in the pocket 140, such belongings being segregated away from the animal. One or more pockets may additionally or replacably be located in interior portions or along other exterior portions of the bag 105. These pockets permit the user 102 to easily carry their belongings as well as the animal within the same enclosure, lessening or eliminating the need for carrying two or more bags or purses. Any of a variety of materials, openings or pockets may be utilized in any of a variety of locations or positions of the bag 105 in an alternative embodiment.

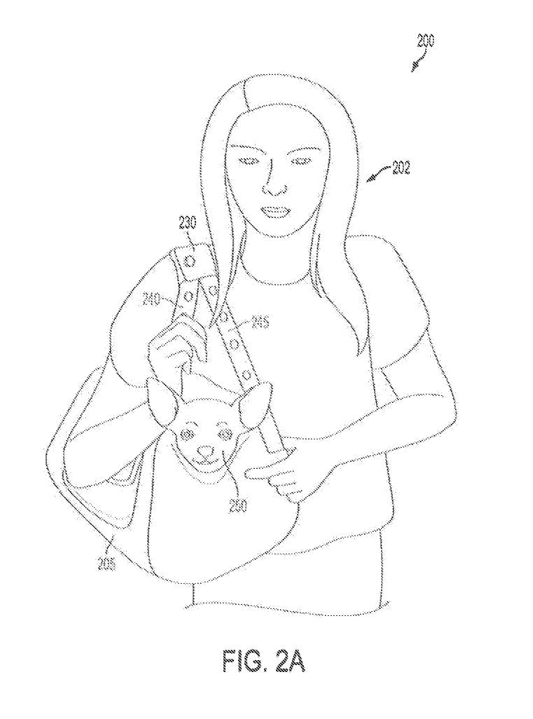

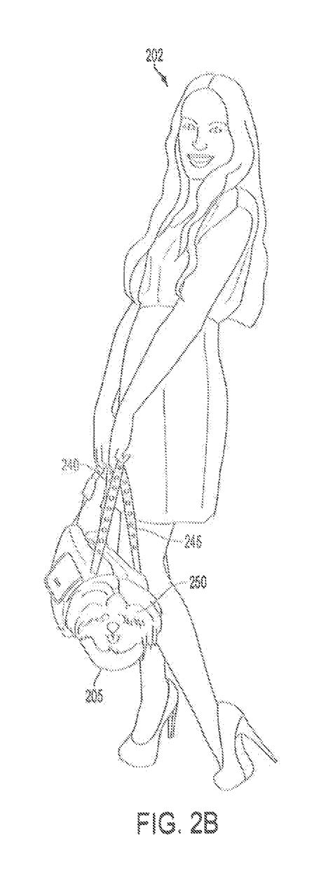

FIG. 2A shows a front view 200 of a portable pet carrier and vehicle transportation bag 205 while being carried by a user 202 via the shoulder of the user. The portable pet carrier and vehicle transportation bag 205 may include the same or similar features as the portable pet carrier and vehicle transportation bag 105 previously discussed for FIG. 1. The hag 205 is shown having an opening (either permanent or closeable) on a front surface such that an animal 250 within the bag 205 is able to protrude their head or other body part out of the opening and outside of the bag 205. Two straps (240, 245) are shown secured to the bag 205 to allow for easier carrying by the user 202. The first strap 240 is affixed to the front of the bag 205 at one corner or side and also is affixed to the back of the bag 205 at one corner or side. The second strap 245 similarly is affixed to the front of the bag 205 at a different corner or side from the first strap 240 and is affixed to the back of the bag 205 at a different corner or side from the first strap 240. As previously discussed for FIG. 1, these straps may be permanently fixed or connectible (e.g., removeably fixed) to the bag 205. Thus, the two straps (240, 245) are substantially parallel with one another and aid in balancing the bag 205 when both are used over a shoulder of the owner 202. A connection flap 230 or other component couples the first strap 240 and the second strap 245 together at a location for more convenient carrying by the user 202. The connection flap 230 may be made of a soft or plush material since it maintains a point of contact with the owner 202 for comfort purposes and may include a snap, Velcro, or other connecting element to help secure the first strap 240 and the second strap 245 together.

FIG. 2B shows a front view of the portable pet carrier and vehicle transportation bag 205 of FIG. 2A with an animal 250 therein and in use during personal carriage via the hands of a user 202. As shown, the user 202 can grip the first strap 240 and the second strap 245 via one or more hands instead of draping the straps (240, 245) over a shoulder. The straps (240, 245) may be maintained in a separated configuration or may use the connection flap 230 (see FIG. 2A) or other coupling element when held by the user 202 in this manner.

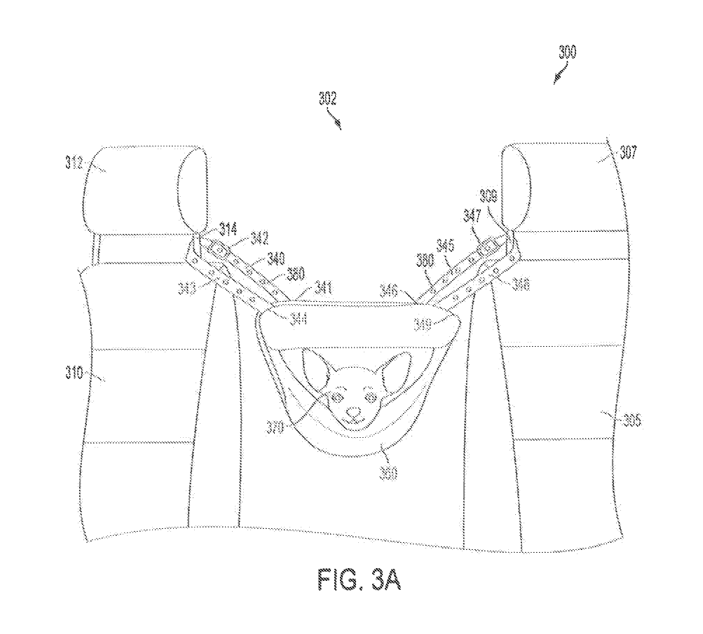

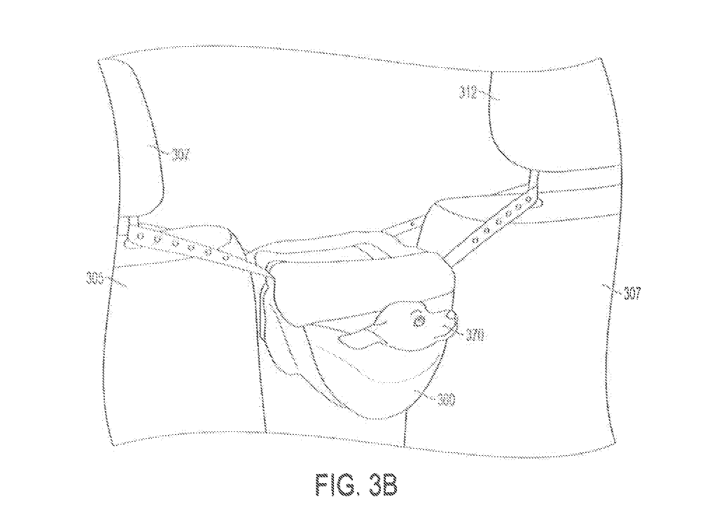

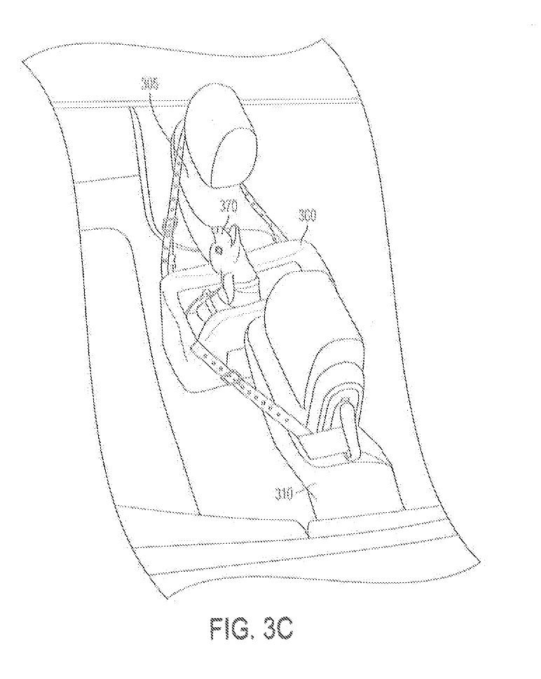

Turning next to FIG. 3A, a front view 300 of a portable pet carrier and vehicle transportation bag 360 is shown in use during automotive travel. The portable pet carrier and vehicle transportation bag 360 may include the same or similar features as the portable pet carrier and vehicle transportation bags previously discussed in FIGS. 1 and 2. The bag 360 includes a body having a plurality of sides (e.g., a bottom side, a top side, a front side, a back side, a first side and a second side) defining a cavity therebetween such that an animal 370 may be received within the cavity and be safely contained within the bag 360 during movement of the automobile. The animal 370 may be permitted to extend out of the bag 360 and look towards a front of the vehicle, as shown. For example, in one embodiment, the bag may unzip at a front and/or back end.

A first seat 305 (e.g., a driver's seat) having a corresponding headrest 307 is located on one side of an interior cabin 302 of the vehicle. Similarly, a second seat 310 (e.g., a passenger's seat) having a corresponding headrest 312 is located on an opposite side of the interior cabin 302 of the vehicle. The bag 360 is configured to be positioned and/or orientated in the space between the first seat 305 and the second seat 310 via removable coupling with the first seat 305 and the second seat 310, as described in greater detail herein.

The body of the bag 360 is connected with a first strap 340, a second strap 343, a third strap 345, and a fourth strap 348. The first strap 340 is affixed to a first corner or portion 341 of the body of the bag 360, the second strap is affixed to a second corner or portion 344 of the body of the bag 360, the third strap is affixed to a third corner or portion 346 of the body of the bag 360, and the fourth strap is affixed to a fourth corner or position 349 of the body of the bag 360. The first strap 340 is configured to connect with the second strap 343, as described in greater detail herein. Similarly, the third strap 345 is configured to connect with the fourth strap 348, as described in greater detail herein. When the first strap 340 is connected to the second strap 343, and the third strap 345 is connected with the fourth strap 348, the resulting combined straps are each connected between the front side and the back side of the body of the bag 360 and may be substantially parallel to one another when carried by a user.

Each of the first strap 340, the second strap 343, the third strap 345 and the fourth. strap 348 include a plurality of holes 380 disposed along their respective lengths. A first buckle 342 or other fastening or coupling device (e.g., Velcro, a clip, a latch, etc.) releasably couples the first strap 340 with the second strap 343. Similarly, a second buckle 347 or other fastening or coupling device releasably couples the third strap 345 with the fourth strap 348. In this manner, the body of the bag 360 may be easily secured within the vehicle via connection of the separable straps around a component of the vehicle, such as headrest bars (314, 309). Moreover, the plurality of holes 380 allows for the total length of the straps resulting from the connection of the first strap 340 to the second strap 343 or from the connection of the third strap 345 to the fourth strap 348 to be adjusted. In this manner, the bag 360 can be secured in a desired position in the space between the two seats (305, 310) and can accommodate a variety of vehicle widths.

In addition, the independently separable straps allows for differing lengths be used on either side of the bag 360. For example, if a passenger sitting in the second seat 310 has the second seat 310 raised higher in the vehicle than a driver sitting in the first seat 305, the body of the bag 360 and any animal 370 contained therein may be desirably orientated in a balanced position by increasing the total length of the resulting strap via the connection of the first strap 340 and the second strap 343. In an alternative embodiment, certain of the straps (340, 343, 345, 348) may not include any holes 380 (e.g., the buckle 342 may be permanently connected to the first strap 340 and adjustably engage with holes 380 of the second strap 343, thus eliminating the need for any holes 380 in the first strap 340). Certain embodiments may not require any holes 380 be used, for example, when using frictional forces of a clip (e.g., a belt clip) to couple the straps without utilizing a buckle with a protruding portion that is received by holes. In one exemplary embodiment, such straps and/or clips may be seat belts with associated seat belt clipping mechanisms to provide strong protection against movement of the bag if the vehicle is in an accident. Moreover, one or more of the straps may include additional add-on straps configured to connect with one or more of the straps (340, 343, 345, 348) for increasing the length of one or more of the straps (340, 343, 345, 348), for example, to be used in vehicles with wide cabin interiors or in vehicles that do not incorporate a headrest configuration as previously discussed.

FIG. 3B shows a perspective view of the portable pet carrier and vehicle transportation bag of FIG. 3A in use during vehicle travel and having an animal able to look toward a rear of the vehicle. The portable pet carrier and vehicle transportation bag 360 may include the same or similar features as the portable pet carrier and vehicle transportation bags previously discussed in FIG. 3A and includes a body defining a cavity there between such that the animal 370 may be received within the cavity and be safely contained within the bag 360 during movement of the automobile. The animal 370 in FIG. 3B is shown extending out of the bag 360 and looking towards a rear of the vehicle. The bag 360 may have openings at both ends of the bag (e.g., via zippered flaps or ends on the from and back portions of the bag) such that the animal 370 can turn around within the bag 360 and extend out towards the front (see FIG. 3A) or the rear of vehicle. Alternatively, the bag 360 may be mountable within the vehicle in reversible directions depending on the desired orientation for the animal 370.

FIG. 3C shows a perspective view of the portable pet carrier and vehicle transportation bag of FIGS. 3A and/or 3B in using during vehicle travel and having an animal able to look toward a roof of the vehicle. The portable pet carrier and vehicle transportation bag 360 may include the same or similar features as the portable pet carrier and vehicle transportation bags previously discussed in FIGS. 3A and/or 3B and includes a body defining a cavity there between such that the animal 370 may be received within the cavity and be safely contained within the bag 360 during movement of the automobile. The animal 370 in FIG. 3C is shown extending out of the bag 360 via a top opening and is looking towards a roof of the vehicle. The bag 360 may additionally have openings at other ends of the bag (e.g., front and back ends) such that the animal 370 can turn around within the bag 360 and extend out towards the front (see FIG. 3A) or the rear (see FIG. 3B) of vehicle. The bag 360 is shown with straps (340, 345) interfacing with other vehicle components (e.g., seat belts or seat belt mechanism) instead of the headrest bars (309, 314) as seen in FIG. 3A. Alternative embodiments of the portable pet carrier and vehicle transportation bag may couple with the vehicle via any of a variety of possible components within the interior cabin of the vehicle.

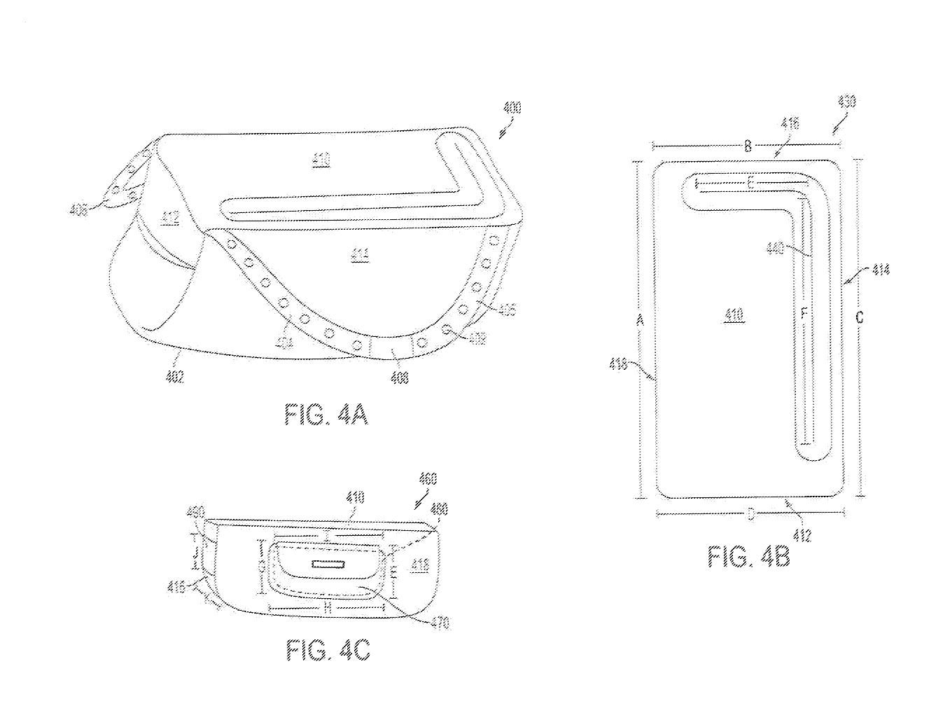

FIGS. 4A-C shows a plurality of exterior views of a portable pet carrier and vehicle transportation bag. FIG. 4A shows a perspective view 400 of the bag having a body 402 connected with a plurality of straps (strap 404, strap 405 strap 406, and another strap obscured from view). The body 402 is made up of six sides: a top side 410, a bottom side (obscured from view and opposite the top side), a front side 412, a back side 416 opposite the front side 412 (see side view 460 of FIG. 4C, discussed below), a first side 414, and a second side 418 (see FIG. 4B) opposite the first side 414 (see side view 460 of FIG. 4C, discussed below). A first strap 404 is secured to the body 402 at a corner of the body 402 formed via the top side 410, the front side 412, and the first side 414. A second strap 405 is secured at a corner of the body 402 formed via the top side 410, the back side 416, and the first side 414. The first strap 404 and the second strap 405 are removably connected to one another via a fastener 408.

The fastener 408 may be a buckle having a protruding element that cooperates with one of the holes 409 disposed along the length of one or more of the first strap 404 and/or the second strap 405. In an alternative embodiment, the fastener 408 may be any of a variety of coupling devices (e.g., snaps, screws, Velcro, clips, etc.) that operate to fasten the first strap 404 with the second strap 405. A third strap 406 is secured at a corner of the body 402 formed via the top side 410, the front side 412, and the second side 418. A fourth strap (obscured from view) is secured at a corner of the body 402 formed via the top side 410, the back side 416, and the second side 418. Like the discussion above, the third strap 406 is removably connected with the fourth strap via a fastener.

FIG. 4B shows a top view 430 of the body 402 of the portable pet carrier and vehicle transportation bag, but without illustrating the above-described straps (404, 405, 406), for clarity purposes. As seen, the top side 410 is connected to each of the front side 412, the hack side 416, the first side 414, and the second side 418. The body 402 may have any of a variety of dimensions desired for holding an animal therein. In a preferred embodiment, the front side 412 may span 8 inches along length “D”, the back side 416 may span 8 inches along length “B”, the first side 414 may span 16 inches along length “C”, and the second side 418 may span 16 inches along length “A.” Although a rectangular configuration is illustrated, in an alternative embodiment, any of a variety of shapes or configurations may be used.

The top side 4101 includes a zipper 440 thereon in a curved or L-shaped orientation for allowing access to the inner volume of the body 402. For example, the zipper 440 may span 6 inches along length “E” and 12 inches along length “F.” An alternative embodiment may use different dimensions or orientations for the zipper. In another embodiment, opening means other than a zipper (e.g., snaps, Velcro, etc.) may be used for providing an opening to the inner volume of the body 402 in replacement of or in addition to the zipper 440. In still another embodiment, the zipper 440 may not be disposed on the top size 410 of the bag, but may be included on any of the other portions or sides of the bag as desired.

FIG. 4C shows a side view 460 of the body 402 of the portable pet carrier and vehicle transportation bag, also illustrated without any of the straps (404, 405, 406), fur clarity purposes. As seen, the second side 418 includes a first pocket 470 secured or included thereon. The first pocket 470 may be made out of a variety of materials, for example faux fur, and can have any of a variety of dimensions. In a preferred embodiment, the first pocket 470 may be substantially rectangular in shape and span 5 inches along length “G” and 7 inches along length “H.” A second pocket 480 (obscured from view, but shown in dotted lines) may be secured or included on the first side 414 of the body 402. The second pocket 480 may be made out of a variety of materials, for example fake leather, and can have any of a variety of dimensions. In a preferred embodiment, the second pocket 480 may be substantially rectangular in shape and span 5 inches along length “E” and 7 inches along length “I.” A back pocket 490 may be secured or included on the back side 416 of the body 402. The back pocket 490 may be made out of a variety of materials and dimensions. In a preferred embodiment, the back pocket 490 may be substantially rectangular in shape and span 5 inches along length “J” and 8 inches along length “K.”

Although six sides for the body 402 of the bag are described, an alternative embodiment can utilize any number of sides or areas to make up a body with an interior cavity contained therein. A side may be a separate piece of material sewn or fastened together at its respective edges to other pieces of material forming other sides. Alternatively, more than one side of the body 402 may be formed by a single piece of material. The locations (or lack thereof) for pockets, straps and other features and the precise dimensions or shape of the bag may be varied depending upon size, carrying characteristics or overall appearance for a desired application. For example, certain other features of the bag may include pouches in place or in addition to pockets, zippered openings to allow easier access to the animal, etc.

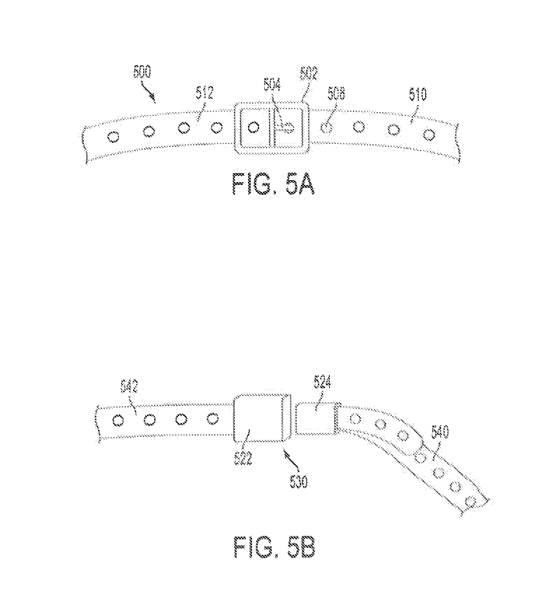

FIGS. 5A-B demonstrate zoomed-in views of a plurality of coupling devices for use in connecting a portable pet carrier and vehicle transportation bag (not shown) to the vehicle. The portable pet carrier and vehicle transportation bag may include the same or similar features as those previously discussed. In FIG. 5A, a front view of a first coupling device 500 is shown. The first coupling device 500 may be in the form of a buckle 502 having a protruding element 504 that cooperates with holes 508 to secure a first strap 510 to a second strap 512. In FIG. 5B, a front view of a second coupling device 530 is shown. The second coupling device 530 may be in the form of a clip or snap having a receiving element 522 and an engaging element 524 that fits at least partially within the receiving element 522 and snaps or otherwise secures in place for connecting a first strap 540 to a second strap 542. The total length of the resulting strap (a combination of the first strap 540 and the second strap 542) may be adjustable by pulling or releasing a portion of the strap 540 through the engaging element 524 as illustrated.

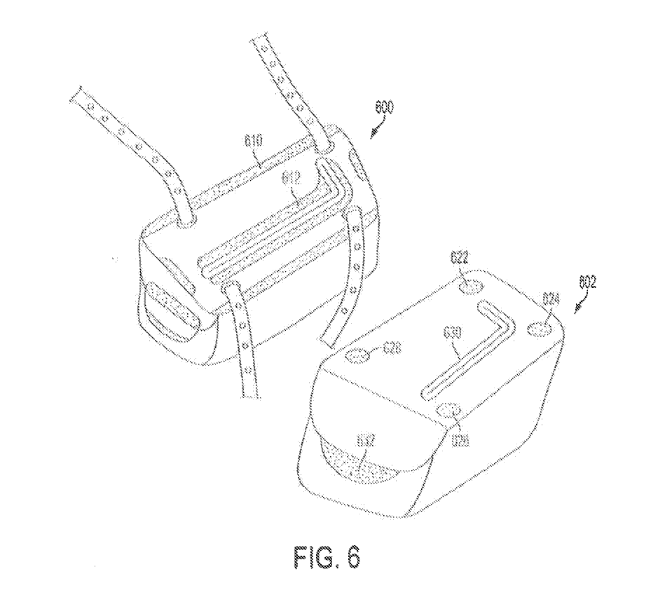

Turning next to FIG. 6, a perspective view of a portable pet carrier and vehicle transportation bag 600 configured to engage with a removable exterior cover 602 is shown. The portable pet carrier and vehicle transportation bag 600 may include the same or similar features as those previously discussed. The removable exterior cover 602 is configured to slip on or over the bag 600 and thus includes a plurality of openings (622, 624, 626, 628, 630, 632) in order to accommodate the various features (e.g., straps, zippers, pockets, etc.) of the bag 602 so as not to impede their use or functionality. The bag 600 includes fastening strips 610 and 612 (e.g., Velcro, snaps, etc.) for engaging with portions of the exterior cover 602 and to help hold the exterior cover 602 in position with the bag 600. In this manner, a user can swap out alternative exterior covers 602, for example, to change the look of the bag 602 for different seasons of the year or for different events. In an alternative embodiment, the exterior cover 602 may be permanently affixed to the bag 602 during manufacturing, for example, with adhesives, to allow for manufacturing of bags with differing looks, but utilizing substantially the same manufacturing process and/or machinery to save on cost.

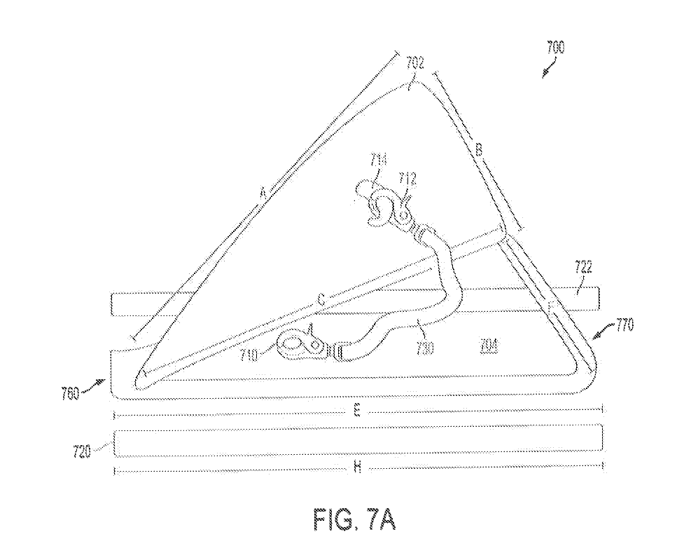

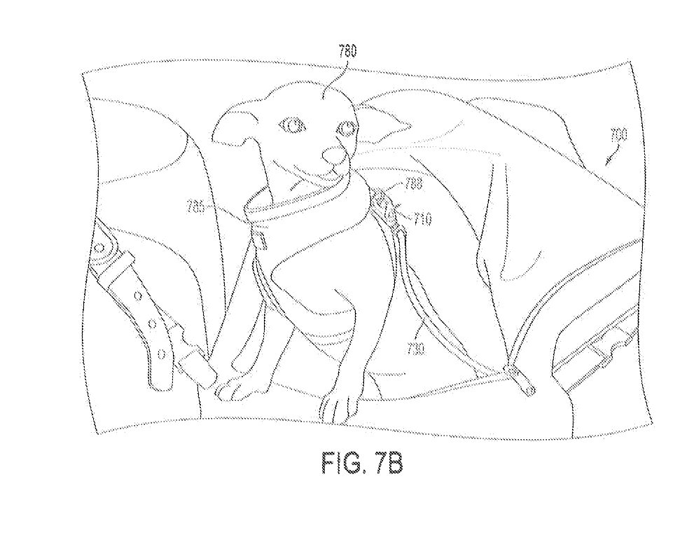

FIG. 7A shows a cut-away, interior view of a portable pet carrier and vehicle transportation bag 700 and also illustrates the opening of a flap 702 positioned on a top side of the bag 700. The portable pet carrier and vehicle transportation bag 700 may include the same or similar features as those previously discussed. The flap 702 may be opened by unzipping a zipper or other closure means (e.g., VELCRO, as previously mentioned) that extends along lengths “A” and “B”, the same or similar as previously discussed, for example in FIGS. 4A-B, giving access to an interior cavity 704 of the bag 700. While any of a variety of dimensions for the closure means may be utilized in an alternative embodiment, the preferred embodiment has length “A” being substantially 12 inches and length “B” being substantially 7 inches. Thus, length “C” extending from one corner of the flap 702 to the other, has a length of substantially 14 inches. A border made of any of a variety of materials may be disposed along lengths “E” and “F” on an exterior surface of the bag 700 for identifying to the user that the flap 702 may be opened. For example, a faux leather material may be disposed along length “E” of substantially 13 inches and along length “F” of substantially 7 inches.

On an interior-facing (when the flap is in the secured position, for example, when a zipper around a portion of its border is closed to otherwise fastened) side of the flap 702, a plurality of clips (710, 712) are mounted (e.g., removably) and a strap 730 or other harness is connected there between. The strap 730 may be used to help secure or maintain an animal within the bag 700 in a desired position.

In one embodiment and as illustrated, the clip 712 may be fastened (e.g., permanently or removably) to a loop 714 or other fabric or connecting element that is part of or coupled with the interior-facing side of the flap 702. The clip 710 may be configured to connect to a harness (e.g., jacket, leash, collar, or other clothing or accessory) that is worn by an animal. In an alternative embodiment, no loop 714 or clip 712 may be needed; the strap 730 instead being, either permanently or removably, attached to a different portion of the bag 700 (e.g., a shoulder strap, such as the shoulder strap illustrated in FIG. 6 that extends through the opening 622. Different embodiments may use any of a variety of alternative positions, orientations, and/or attachments for helping maintain the animal within the 700 via a strap or harness. Thus, when the clip 710 is fastened to the animal and the clip 712 is fastened to the flap 702, the movement of the animal may be restricted when inside of the bag. This may be useful to help keep the animal in a desired orientation during travel, for example, to aid in the safety of the animal and/or for convenience of the animal's owner.

Preferably, the strap 730 will have a length between 5-10 inches, but any length may be used in an alternative embodiment. For example, in some embodiments, the length of the strap 730 may be adjustable. The strap 730 may be removable from one or both of the clips (710, 712). The clips (710, 712) may also be configured to secure to other items that a user may wish to keep within the bag 700 with the animal (e.g., a pouch of dog treats, a water bottle, etc.) in place of or in addition to the strap 730.

As illustrated via the cut-away drawing of FIG. 7A, inside of the bag 700, a plurality of stabilizing bars, rods, or wires (720, 722) are positioned to extend along length “H” from a front portion 760 to a back portion 770. The bars, rods, or wires (720, 722) may be dowels or wires made from wood, plastic, or any of a variety of materials and operate to help maintain the bag shape and increase stability when an animal is contained within the bag 700. In an alternative embodiment, the bars, rods, or wires (720, 722) may be a stable rod, wire, or a moldable, flexible wire that extends around all or a portion of the bag.

These bars, rods, or wires (720, 722) may be configured to be removable (e.g., not permanently sewn or affixed into the bag), for example, in order to wash the bag, or for ease in replacement of broken bars, rods, or wires (720, 722). For example, in one embodiment, the bag may include an interior lining that is configured to be removable such that the bag maintains a more solid or consistent shape when the lining is disposed within, and the bag is more collapsible when the lining is removed. In either case, the bag would still be functional for containing all or a portion of a pet within. The lining may be any of a variety of materials or components (e.g., the bars, rods, or wires previously discussed) and may include a bottom surface for providing a comfortable surface for a pet traveling within the bag. The lining may be permanently sewn into the bag, or attached via less permanent means (e.g., Velcro, a snap system, etc.).

While the bars, rods, or wires (720, 722) may be any of a variety of lengths, the preferred embodiment has length “H” being substantially 14 inches. The bars or rods (720, 722) may be sewn into a pocket formed along the interior of the bag or otherwise attached to the bag 700 (e.g., via an adhesive). While two bars or rods (720, 722) are shown, an alternative embodiment may use greater or fewer stabilizing elements as desired and/or positioned inside or along an exterior of the bag. Any of a variety of stability b

FIG. 7B shows an animal 780 connected with the portable pet carrier and vehicle transportation bag of FIG. 7A via the strap 730. As shown, a vest 785 or other wearable element is worn by the animal 780. The vest 785 includes a loop 788 that is configured to cooperate with the clip 710 and/or 712. Thus, as illustrated, the clip 710 that is connected with the strap 730 may be secured to the loop 788 of the vest 785 and the clip 712 (not shown) that is also connected with the strap 730 may be secured to a flap (e.g., flap 702 shown in FIG. 7A) or other area or element of the bag 700 for maintaining the animal 780 within the bag 700.

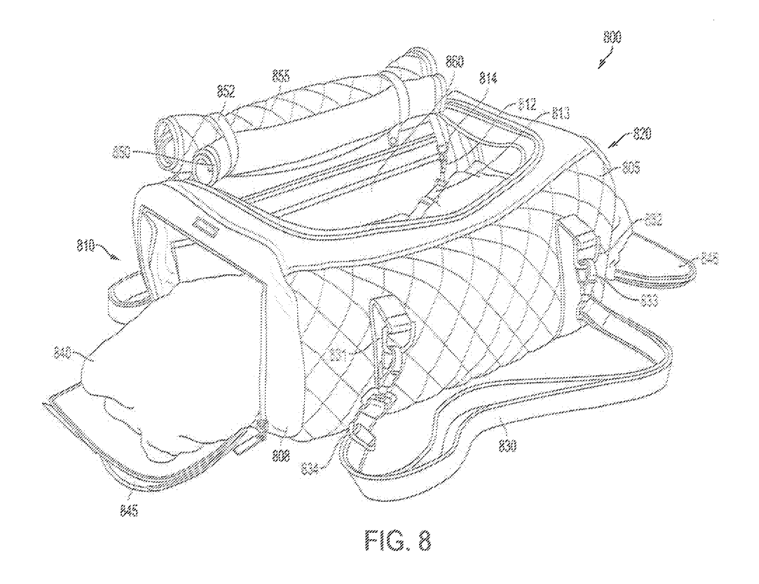

FIG. 8 shows a perspective view 800 of a portable pet carrier and vehicle transportation bag 805. The portable pet carrier and vehicle transportation bag 805 may include the same or similar features to those previously discussed. As shown, the bag 805 includes a body portion 808 that has a front end 810 and a rear end 820. The body portion 808 defines an interior space or cavity within for the placement of an animal and/or other belongings or contents. One or more openings in the body portion 808 permit a user to access the cavity of the body portion 808. For example, as illustrated and as previously discussed, these openings may be in one or more of the front end 810, the rear end 820, the top, the bottom, or any other portion of the body portion 808. One or more flaps may be used to open or close the one or more openings in the body portion 808, for example, in order to secure an animal within the cavity of the body portion 808 so that the animal cannot escape. A liner 840 made of a plush and/or easily cleanable material may be provided within the cavity of the body portion 808 for animal comfort. This liner 840 may be removeable so that it can be cleaned independent of the bag 805 (e.g., washed to remove animal waste, vacuumed to remove animal hair, etc.)

In one embodiment and as shown, a first flap 850 may be configured to open or close an opening in the top of the bag. The first flap 850 may be made out of a mesh material, as previously mentioned, for example, for FIG. 1. This may, in one embodiment, allow an animal to peer out of the bag 805 and/or for another user to look into the bag 805 without having to open up the body portion 808. A second flap 855 may be configured to open or close an opening in the top of the bag in proximity to the first flap 850. In one embodiment, the second flap 855 may be made out of the same material as at least a portion of the body portion 808. Thus, as shown, the first flap 850 may couple with the body portion 808 around at least a perimeter of the opening in the top of the bag, while the second flap 855 may couple with the body portion 808 around at least a perimeter of the first flap 850. Either or both of the first flap 850 and/or second flap 855 may cooperate to open or close with the body portion via a zipper, VELCRO, or any other fastenable means. The bag 805 may, therefore, include dual flaps that open or close an opening in the body portion 808 of the bag 805, independent of one another. A securing element 852, such as a strip of fabric that ties, snaps, or otherwise is capable of holding one or both of the first flap 850 and/or second flap 855 can hold the flaps in the open configuration. The same or similar flaps of varying materials may be used at any location of an opening in the body portion 808 of the bag 805 in an alternative embodiment.

The body portion 808 may couple with one or more straps 830 along an exterior surface of the body portion 808. For example, hooks (831, 832) (such as D-rings) may fasten with the exterior surface of the body portion 808 and cooperate with fasteners 833 (e.g., clips) that are connected at each end of the strap 830. Thus, a first fastener at one end of the strap 830 may connect with one hook 831 while a second fastener at a second end of the strap 830 may connect with a second hook 832. The strap 830 may have an adjustable length, as previously mentioned above, for example, for FIG. 5. In one embodiment, a buckle 834 cooperates with a portion of the strap to lengthen or shorten the overall length of the strap that may connect between the two hooks (831, 832).

Similarly, one or more adjustable or non-adjustable interior straps 813 may couple with an interior surface of the body portion 808, within the cavity. In one embodiment, the interior strap 813 may have a fastener 812 (e.g., a clip) at one end that is configured to cooperate with a hook 814 (e.g., a D-ring) that is coupled with the interior surface of the body portion 808. The interior strap 813 may have a second fastener at another end of the strap 813 that is configured to couple with a harness (e.g., jacket, leash, collar, or other clothing or accessory) worn by an animal.

The exterior strap 830 and/or the interior strap 813 may be completely removed from the bag 805 and used for other purposes, for example, as a leash, harness, or tether for a pet or animal. In one embodiment, the length of the exterior strap 830 and/or the interior strap 813 may automatically adjust (e.g., expand or retract). In this fashion, either or both of the straps (830, 813) may be used as an auto-expanding or auto-retracting leash for an animal when disconnected from the bag 805.

The bag 805 shown in FIG. 8 also includes an interior pocket 860 that may be completely closeable in order to prevent an animal within the cavity of the body portion 808 from having access to the contents within the pocket 860. In another embodiment, the interior pocket 860 may not be completely closeable. The interior pocket 860 may be configured to removeably hold, or may permanently hold, a temperature altering element, such as a heating packet, cooling packet, etc.) that helps raise or lower the temperature of the cavity of the body portion 808. In the case of a permanently held element, the pocket 860 itself may be removeable and/or replaceable on the body portion 808, for example, via snaps, ties, or other fastening methods.

In one embodiment, as shown, the bag 805 may contain a removeable front end or flap 845 and a removeable rear end or flap 846. One or both of these flaps (845, 846) may be completely removeable from the body portion 808 of the bag 805 such that they can be completely disconnected and used for other purposes. One or both of these flaps (845, 846) may be configured to hold a volume of fluid (e.g., water) and/or items (e.g., pebbles of dry pet food or amounts of wet pet food). Thus, one or both of these flaps (845, 846) can be removed from the bag 805 when the bag is not being used to carry an animal and be used for holding that animals food and/or water. In one example, at least a portion of one or both of these flaps (845, 846) may form a concave shape for holding the volume of fluid and/or items. In another example, at least a portion of one or both of these flaps (845, 846) may be made of a fluid-impermeable material for holding the volume of fluid and/or items. In another embodiment, additional or alternative portions or components may connect or disconnect with the body portion 808 of the bag 805 to be used as to hold fluid or items when the bag 805 is not in use.

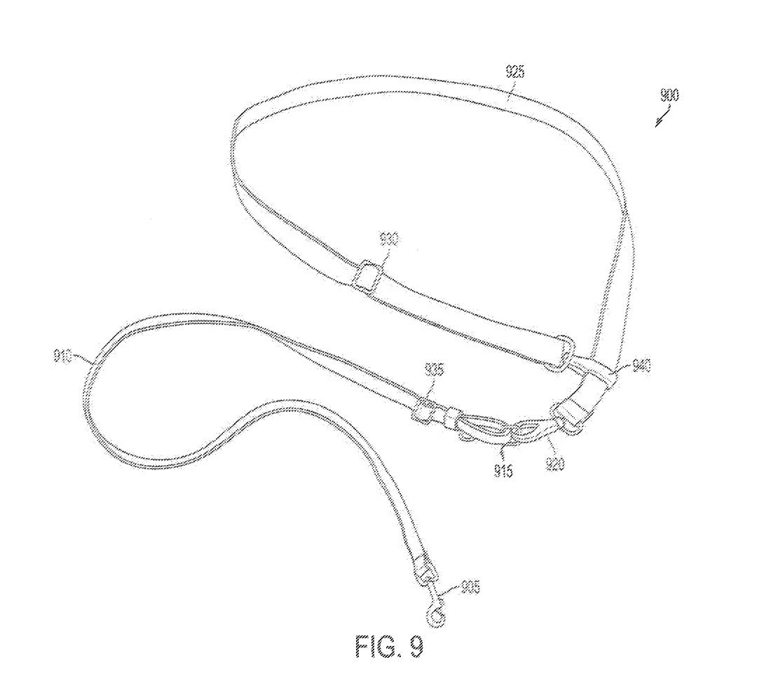

FIG. 9 shows an exemplary belt and/or leash combination 900 that is formed via removable straps from a portable pet carrier and vehicle transportation bag (e.g., the portable pet carrier and vehicle transportation bag 805 previously discussed. The belt and/or leash combination 900 may be configured to attach around the waist of a user via a first strap 925 and engage with a second strap 910 for facilitate handless walking of a pet, as discussed in greater detail below.

For example, the first strap 925 may be a strap that is removable from a portable pet carrier and vehicle transportation bag (e.g., from an exterior of the bag, such as strap 830 for FIG. 8). The first strap 925 may include a first fastener 920 (e.g., a clip) at a first end of the first strap 925 and a second fastener 940 (e.g., a clip) disposed at a second end of the first strap 925. One or more buckles 930 may be disposed along a length of the first strap 925 in order to adjust an overall length of the first strap 925. The second fastener 940 may be configured to engage with a portion of the first strap 925 in order to form a looped configuration with the first strap 925 (e.g., in order to be placed and maintained around a waist of a user). Hooks (such as D-rings) may be used for connecting one or both of the first and second fasteners (920, 940) to the first strap 925, the same or similar as previously discussed. The first and second fasteners (920, 940) may be the same type of fastener, as illustrated, or may be different from one another in an alternative embodiment.

The second strap 910 may also be a strap that is removable from the portable pet carrier and vehicle transportation bag (e.g., from an interior of the bag, such as strap 813 for FIG. 8). The second strap 910 may include a first fastener 905 (e.g., a clip) at a first end of the second strap 910 and a second fastener 915 at a second end of the second strap 910. As shown, the first and second fasteners (905, 915) of the second strap 910 may be different from one another, or, in an alternative embodiment, may be the same type of fastener. Similar to the first strap 925, one or more buckles 935 may be disposed along a length of the second strap 910 in order to adjust an overall length of the second strap 910. The first fastener 920 of the first strap 925 is configured to engage with the second fastener 915 of the second strap 910.

In this fashion, for example, when the first strap 925 is disposed around the waist of a user (e.g., as a belt), the second strap 910 may connect between the first strap 925 and a harness of an animal (e.g., as a leash) to facilitate leashed walking or securing of the animal without requiring the user to use their hands. In an alternative embodiment, any combination of straps may be removable from a portable pet carrier and vehicle transportation bag to accommodate leashed securing of an animal. For example, only the exterior or only the interior strap or straps may be removable. In one embodiment, one removable strap may be configured to look around the waist of a user while a traditional leash is connected thereto in place of or in addition to the second strap 910. In still another embodiment, either or both of the first strap 925 and/or the second strap 910 may be held by the user to walk or secure the animal without looping around the waist.

Many modifications may be made to any of the portable pet carrier and vehicle transportation bag described above, but remain within the scope of the invention. In one embodiment, the portable pet carrier and vehicle transportation bag may additionally be configured for airport travel. Due to the increased security at airports regarding carry-on luggage, many bags are subject to heightened scrutiny by airport security personal. The portable pet carrier and vehicle transportation bag may be enclosed with a mesh or other transparent screening for making the bag airport-approved or more convenient for an individual carrying the bag to move through airport security checkpoints without hassle.

In another embodiment, the portable pet carrier and vehicle transportation bag may be configured for holding multiple animals within. For example, a zipper or opening on a top side of the bag may provide access to two or more separate or segregated compartments within the bag, each compartment adapted to hold one animal within. In this manner, multiple animals may be carried by the bag, but isolated from one another for their comfort or to prevent quarrels between the animals. As discussed above, any straps or clips located within an interior of the bag may be duplicated in each compartment.

The previous description of the disclosed examples is provided to enable any person of ordinary skill in the art to make or use the disclosed methods and apparatus. Accordingly, the terminology employed throughout should be read in a non-limiting manner. For example, terms such as front, back or rear, side, top, bottom, etc. are used to identify relationships between various portions or areas of the bags that are illustrated for descriptive purposes and not to limit the invention to any particular orientation. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and/or methods.

What is claimed:

1. An enclosure for an animal comprising:
a body defining a cavity therein for receiving the animal, the body having at least one opening for allowing access to the cavity of the body;
a first flap configured to close the opening by coupling with the body around at least a portion of the perimeter of the opening;
a second flap configured to cover the first flap by coupling with the body around at least a perimeter of the first flap;
an adjustable exterior strap having a first fastener at a first end and a second fastener at a second end, the adjustable exterior strap coupled with the body via the first fastener and the second fastener; and
an interior strap having a first fastener at a first end and a second fastener at a second end, the interior strap coupled with the body, within the cavity, via the first fastener.

2. The enclosure of claim 1 wherein the first flap is made of a mesh material.

3. The enclosure of claim 2 wherein the second flap is made of the same material as at least a portion of the body.

4. The enclosure of claim 3 wherein the first flap is configured to close the opening of the body via a zipper.

5. The enclosure of claim 3 wherein the first flap is configured to close the opening of the body via VELCRO.

6. The enclosure of claim 1 further comprising a first hook coupled to an exterior of the body and a second hook coupled to the exterior of the body, wherein the first fastener of the adjustable exterior strap is configured to couple with the first hook and the second fastener of the adjustable exterior strap is configured to couple with the second hook.

7. The enclosure of claim 6 wherein the adjustable exterior strap is configured to adjust in length via a buckle disposed at a position along a length of the strap.

8. The enclosure of claim 6 wherein the first fastener of the adjustable exterior strap is configured to couple with a harness worn by the animal.

9. The enclosure of claim 1 further comprising a first hook coupled to an interior of the body, wherein the first fastener of the interior strap is configured to couple with the first hook.

10. The enclosure of claim 9 wherein the first fastener of the interior strap is configured to couple with a harness worn by the animal.

11. An enclosure for an animal comprising:
a body defining a cavity therein for receiving the animal, the body having an opening for allowing access to the cavity of the body; and
a flap coupled with the body and configured to be completely removeable from the body,
wherein the flap is configured to hold a volume of fluid thereon when removed from the body.

12. The enclosure of claim 11 wherein at least a portion of the flap forms a concave surface for the holding of the volume of the fluid.

13. The enclosure of claim 12 wherein at least a portion of the flap is made of a fluid-impermeable material for the holding of the volume of the fluid.

14. The enclosure of claim 11 wherein the flap is coupled to the body via a zipper that extends around at least a portion of the perimeter of the flap.

15. The enclosure of claim 11 wherein the flap is coupled to the body via VELCRO that extends around at least a portion of the perimeter of the flap.

16. An enclosure for an animal comprising:
a body defining a cavity therein, the body having an opening for allowing access to the cavity of the body;
a pocket coupled with the body within the cavity, the pocket configured to hold a temperature altering element for altering a temperature within the cavity of the body;
an adjustable strap having a first fastener at a first end and a second fastener at a second end, the adjustable strap configured to removeably couple with the body via the first fastener or the second fastener,
wherein the adjustable strap is configured to be completely removed from the body and used as a leash for the animal.

17. The enclosure of claim 16 wherein the temperature altering element is a heating packet or a cooling packet.

18. The enclosure of claim 16 wherein the pocket is configured to be completely closeable so that the animal is prevented from accessing the temperature altering element when the temperature altering element is closed within the pocket.

19. The enclosure of claim 17 wherein the first fastener of the adjustable strap is a clip that is configured to fasten to a harness of the animal to be used as the leash for the animal.

20. The enclosure of claim 18 wherein a length of the adjustable strap between the first end and the second end is configured to automatically expand or retract if used as a leash for the animal.
